(19) United States
(12) Patent Application Publication
(10) Pub. No.: US 2018/0186951 A1
(43) Pub. Date: Jul. 5, 2018

(54) METHODS OF MANUFACTURE OF PREPREGS AND COMPOSITES FROM POLYIMIDE PARTICLES, AND ARTICLES PREPARED THEREFROM

(71) Applicant: SABIC Global Technologies B.V., Bergen op Zoom (NL)

(72) Inventors: Viswanathan Kalyanaraman, Newburgh, IN (US); Kapil Inamdar, Columbus, IN (US)

(21) Appl. No.: 15/737,639

(22) PCT Filed: Jun. 29, 2016
(86) PCT No.: PCT/US2016/039942

§ 371 Date: Dec. 18, 2017

Related U.S. Application Data
(60) Provisional application No. 62/186,587, filed on Jun. 30, 2015.

(51) Int. Cl. C08J 5/24; C08J 3/14; B32B 5/12; B32B 5/26

(52) U.S. Cl. CPC C08J 5/24; C08J 3/14; B32B 5/12; B32B 5/26; C08J 2379/08; B32B 2305/10; B32B 2260/021; B32B 2260/046; B32B 2262/106; B32B 2264/0214; B32B 2250/44

(57) ABSTRACT

A method of manufacturing a polyimide prepreg, including: coating a substrate with an aqueous polymer dispersion comprising polyimide particles having a spherical morphology and a volume based D100 diameter less than 100 micrometers and a volume based D90 diameter less than 60 micrometers and a volume based D50 diameter less than 40 micrometers, to form a coated substrate; and heating the coated substrate to form a polyimide prepreg. The prepregs can be formed into laminates or 3-dimensional composite articles.

### CROSS-REFERENCE TO RELATED APPLICATIONS

This application claims priority from U.S. Provisional Patent Application Ser. No. 62/186,587, filed Jun. 30, 2015, the contents of which are hereby incorporated by reference in their entirety.

### BACKGROUND

Thermoplastic polymers such as polyimide (PI) are commonly used in thermoplastic prepregs and composites. As known in the art and used herein, a thermoplastic prepreg is a substrate, generally fibrous, pre-impregnated with the thermoplastic polymer. Multiple prepregs can be combined under heat and pressure to form a composite using various commercially available processes. Both prepregs and composites can be in a variety of forms as described in further detail below. For example, prepregs can be in the form of continuous, unidirectional fibers pre-impregnated with the thermoplastic polymer (often referred as unidirectional tapes, or “UD tapes”). Composites that have been formed by consolidation of two or more layers of a prepreg, such as two or more layers of a tape, are often referred to as laminates.

Thermoplastic prepregs or composites can be produced using numerous processes such as melt impregnation, solvent/solution impregnation, powder scattering, or aqueous bath impregnation. For example, one method of manufacturing thermoplastic composites is by melting thermoplastic polymer pellets and impregnating fiber reinforcements such as glass or carbon with the molten polymer. Melt impregnation of fiber reinforcements can have its own processing challenges depending on the type of thermoplastic polymer and its thermal properties, which play an important role in the polymer viscosity behavior and ability to impregnate the reinforcing fibers. One way to improve the polymer melting process and subsequent fiber wetting is to increase the processing temperatures used to make the thermoplastic composite, or to reduce the rate of production of the thermoplastic composite. These methods can result in degradation of the polymer due to increased exposure to high temperatures, which can also be detrimental to the composite properties. This disadvantage is particularly acute in the case of polyimide, because polyimides generally have a higher glass transition temperature and high viscosity, so it is difficult to achieve a high quality of fiber impregnation using polyimide as a matrix material. In the case of solvent/solution impregnation, some of the challenges include solvent recyclability, reducing the residual solvent in the final prepreg/laminate, and finding an eco-friendly solvent.

There accordingly still remains a continuing need for improvement in the currently available methods for manufacturing polyimide pre-preg, their composites, and articles made therefrom.

### BRIEF DESCRIPTION

Disclosed herein are methods of manufacturing polyimide prepregs, polyimide composites made from the prepregs, and articles formed therefrom.

In particular, the inventors hereof have developed a method of manufacturing a polyimide prepreg, including coating a substrate with an aqueous polymer dispersion to form a coated substrate, wherein the aqueous polymer dispersion comprises polyimide particles having a spherical morphology, and a volume based D100 diameter less than 100 micrometers, and a volume based D90 diameter less than 60 micrometers, and a volume based D50 diameter less than 40 micrometers, or polyimide particles having a volume based D100 diameter from 1 to 100 micrometers, and a volume based D90 diameter from 1 to 60 micrometers, and a volume based D50 diameter from 1 to 40 micrometers, optionally wherein the polyimide particles have a mono-modal, bi-modal, tri-modal or multi-modal volume based size distribution; and heating the coated substrate to form the polyimide prepreg.

A method of manufacturing a polyetherimide prepreg, comprising: pulling a substrate, preferably carbon fibers, through an aqueous polymer dispersion for less than 30 minutes, the aqueous polymer dispersion comprising 0.5 to 30 wt %, preferably 0.5 to 4 wt % of polyetherimide particles having a spherical morphology, and a volume based D100 diameter less than 100 micrometers, and a volume based D90 diameter of less than 60 micrometers, and a volume based D50 diameter of less than 40 micrometers, and from 0.1 to 10 wt %, preferably from 0.2 to 5 wt %, more preferably from 0.2 to 3 wt % of an additive composition comprising a surfactant, a stabilizer, a colorant, a filler, a polymer latex, a coalescing agent, a co-solvent, or a combination comprising at least one of the foregoing, wherein the wt % is based on the total weight of polymer in the aqueous polymer dispersion, to form a coated substrate; and heating the coated substrate to between 200 and 550° C. for less than 15 minutes, to form a fiber reinforced polyetherimide prepreg, preferably in the form of a continuous unidirectional fiber reinforced tape is provided.

Polyimide prepregs, specifically polyetherimide prepregs, made by the above method are also provided, as well as composites made from the prepregs.

A laminate comprising at least two, preferably from two to one hundred layers of a polyimide prepreg, specifically a polyetherimide prepreg, formed by the above-described method is also provided.

Articles comprising the polyimide prepreg, polyetherimide prepreg, and composites, for example laminates produced therefrom, are also provided.

The above described and other features are exemplified by the following Figures and detailed description.

### BRIEF DESCRIPTION OF THE DRAWINGS

Referring now to the drawings, which are exemplary and not limiting.

FIG. 1 shows Scanning Electron Microscope (SEM) images of polyetherimide particles formed from a jet milling process (left) and an emulsion process (right).

FIG. 2 is an ultrasonic C-scan of a polyetherimide prepreg formed using polyetherimide particles having a volume based D100 diameter less than 60 micrometers formed from an emulsion process.

FIG. 3 is an optical microscope image of a unidirectional (UD) polyetherimide tape produced using laminate formed using polyetherimide particles having a volume based D100 diameter less than 60 micrometers formed from an emulsion process.

FIG. 4 is an ultrasonic C-scan of a polyetherimide prepreg formed using polyetherimide particles formed from a jet milling process.

FIG. 5 is an optical microscope image of a polyetherimide laminate formed using polyetherimide particles formed from a jet milling process.

FIG. 6 shows the autoclave process cycle used to prepare laminates as described herein.

### DETAILED DESCRIPTION

Described herein is a method of manufacturing polyimide prepregs and composites using polyimide particles having a spherical morphology and specified size parameters. The method produces composites with improved properties. The method is particularly useful for the production of tapes, for example UD tapes, and laminates, including laminates made from two or more UD tapes. Although Applicant is not required to provide a description of any theory of the operation and the appended claims should not be limited by applicant statements regarding such theory, it is thought that polymer particles having the properties described herein provide good wetting of fibers and few voids when used to manufacture a polyimide prepreg or composite.

More specifically, provided is a method of manufacturing a polyimide prepreg, including: coating a substrate with an aqueous polymer dispersion including polyimide particles having a spherical morphology and a volume based D100 diameter of less than 100 micrometers, and a volume based D90 diameter of less than 60 micrometers, to form a coated substrate; and heating the coated substrate to form a polyimide prepreg. The polyimide particles can have a volume based D50 diameter of less than 40 micrometers. The polyimide particles can have a volume based D100 diameter from 1 to 100 micrometers and a volume based D90 diameter from 1 to 60 micrometers and a volume based D50 diameter from 1 to 40 micrometers. The volume based D100 diameter of the polyimide particles can be less than 45 micrometers, preferably less than 40 micrometers. The volume based D100 diameter of the polyimide particles can be from 1 to 45 micrometers, preferably from 5 to 40 micrometers, more preferably from 10 to 30 micrometers.

The polyimide particles can be sieved or otherwise sized to narrow the size distribution. The volume based D100 diameter of the polyimide particles can be 70 micrometers, preferably less than 60 micrometers, and a volume based D90 diameter less than 40 micrometers, preferably less than 30 micrometers, and a volume based D50 diameter less than 20 micrometers, preferably less than 10 micrometers.

The polyimide particles can have a mono-modal, bi-modal, tri-modal or multi-modal volume based size distribution, where there is more than one maximum particle diameter and more than one distribution of particle diameter. Each mode in a mono-modal, bi-modal, tri-modal or multi-modal volume based size distribution can be described as volume based D100, D90, or D50 diameter. The distributions can overlap.

Although Applicant is not required to provide a description of any theory of the operation and the appended claims should not be limited by applicant statements regarding such theory, it is believed that when the polyimide particles have a spherical morphology the substrate has a greater pick-up of particles than when the polyimide particle is not spherical. The particle pick-up can simply be measured by the areal weight of the prepreg, with existing knowledge of the weight of dry continuous fibers over a finite linear dimension. A greater areal weight of the prepreg is an indication of greater particle pick-up by the substrate during prepreg production. A prepreg having a higher polymer particle pick-up can have fewer particles that disengage or otherwise are removed during the down stream processing used to form a prepreg. Having fewer particles that disengage or otherwise removed can allow the use of a higher speed process prepreg production.

The polyimide particles can be prepared by an emulsion-based process, such as that described in U.S. patent application publications 2012/0245239, 2014/0275365 and 2014/0272430. The emulsion-based process to produce spherical polyimide particles is described here. Polyimide particles can be dissolved in an organic solvent. The polyimide particle solution can be emulsified with an aqueous solution including a surfactant using shear mixing, an agitator or mixing blades, for example. Organic solvent can be removed by heating the emulsion above the boiling point of the organic solvent, for example, to form an aqueous polymer dispersion. The concentration of the polyimide particles in the aqueous polymer dispersion can be from 0.5 to 30 weight percent (wt %), preferably from 1 to 25 wt %, more preferably from 2 to 10 wt %, more preferably from 1 to 8 wt %, wherein the weight percent is based on the total weight of the aqueous polymer dispersion.

Coating the substrate with the aqueous polymer dispersion can be by any suitable method, including immersing the substrate into the aqueous polymer dispersion, for a suitable time, preferably for up to 30 minutes, more preferably for up to 15 minutes; pulling the substrate through the aqueous polymer dispersion; spraying the aqueous polymer dispersion onto the substrate; curtain coating the substrate with the aqueous polymer dispersion, or a combination including at least one of the foregoing.

Heating the coated substrate to form a polyimide prepreg can include drying at a temperature from 80 to 230° C., preferably 100 to 220° C., and melting at a temperature from 200 to 570° C. preferably 220 to 550° C. for a total heating time of less than 15 minutes. The total heating time (drying and melting) can be from 1 second to 15 minutes, preferably from 5 seconds to 10 minutes.

The aqueous polymer dispersion can include a total percent of 0.01 to 10 wt %, preferably 0.01 to 5 wt % of an additive composition including additives known for use in the intended application, provided that the additive or combination of additives does not substantially adversely affect the desired properties of the composite, wherein the wt % of the additive is based on the total weight of the polymer in aqueous dispersion. The additive composition can include a surfactant (which can be the same or different than the surfactant used to form the aqueous polymer dispersion), a stabilizer, a colorant, a filler, a polymer latex, a coalescing agent, a co-solvent, an adhesion promoter (e.g., a silane or titanate), or a combination including at least one of the foregoing, wherein the wt % is based on the total weight of the aqueous polymer dispersion. The additive can be a surfactant or a coalescing agent.

The substrate can be any suitable material that can be coated with the aqueous polymer dispersion. The substrate can include organic or inorganic materials such as wood, cellulose, metal, glass, carbon (e.g., pyrolyzed carbon, graphite, graphene, nanofibers, or nanotubes), polymer, ceramic, or the like. A combination of different materials can be used. In an embodiment, an electrically conductive material. e.g., a metal such as copper or aluminum, or an alloy thereof, can be used. In some embodiments a fibrous substrate is preferred. The fiber can be inorganic fiber, for example ceramic fiber, boron fiber, silica fiber, alumina fiber, zirconia fiber, basalt fiber, metal fiber, or glass fiber; or organic fiber, for example a carbon fiber or polymer fiber. The fibers can be coated with a layer of conductive material to facilitate conductivity. The fibers can be monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. The fibrous substrate can be a woven or co-woven fabric (such as 0-90 degree fabrics or the like), a non-woven fabric (such as a continuous strand mat, chopped strand mat, tissues, papers, felts, or the like), unidirectional fibers, braids, tows, roving, rope, or a combination including at least one of the foregoing. Co-woven structures include glass fiber-carbon fiber, carbon fiber-aromatic polyimide (aramid) fiber, and aromatic polyimide fiberglass fiber or the like. In some embodiments the substrate can comprise a glass fiber, a carbon fiber, or a combination including at least one of the foregoing. The substrate can be a carbon fiber tow. A carbon fiber tow can include any number of individual carbon fiber filaments, such as up to 60,000 or 80.000.

In some embodiments the substrate can be unsized fibers or surface treated fibers to enhance adhesion of the polyimide, for example plasma or corona treated; or treated with a primer such as a silane or a titanate. Fiber sizing agents can be used, such as those sizing agents based on polyimides, polyamides, polyurethanes, epoxy, or polyesters. Sizing agents can be used in any amount suitable for the desired purpose, such as from 0.001 wt % up to 2 wt %, based on the total weight of carbon fibers.

Although Applicant is not required to provide a description of any theory of the operation and the appended claims should not be limited by applicant statements regarding such theory, it is thought that when the spherical polyimide particles and fiber have similar diameter, such as when at least a portion of the particle size distribution of the polyimide particles and the fiber overlap, the uptake of polyimide particles can be higher than in situations when the polyimide particles are non-spherical.

Polyimides comprise more than 1, for example 10 to 1000, or 10 to 500, structural units of formula (1)

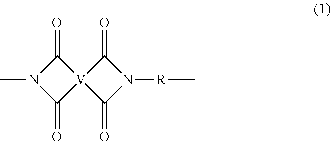

wherein each V is the same or different, and is a substituted or unsubstituted tetravalent C₄₋₄₀ hydrocarbon group, for example a substituted or unsubstituted C₆₋₂₀ aromatic hydrocarbon group, a substituted or unsubstituted, straight or branched chain, saturated or unsaturated C₂₋₂₀ aliphatic group, or a substituted or unsubstituted C₄₋₈ cycloalkylene group or a halogenated derivative thereof, in particular a substituted or unsubstituted C₆₋₂₀ aromatic hydrocarbon group. Exemplary aromatic hydrocarbon groups include any of those of the formulas

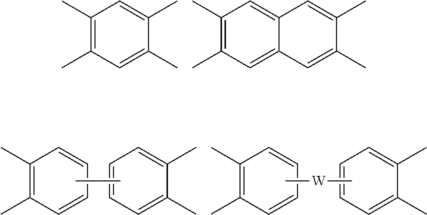

wherein W is —O—, —S—, —C(O)—, —SO₂—, —SO—, —C_{y}H_{2y}— wherein y is an integer from 1 to 5 of a halogenated derivative thereof (which includes perfluoroalkylene groups), or a group of the formula T as described in formula (3) below.

Each R in formula (1) is the same or different, and is a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of formulas (2)

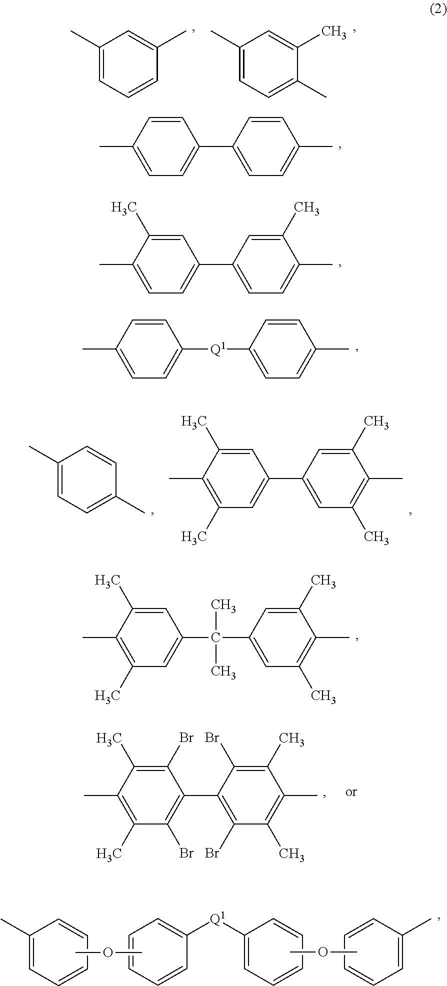

wherein Q¹ is —O—, —S—, —C(O)—, —SO₂—, —SO—, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In an embodiment R is m-phenylene, p-phenylene, or a diaryl sulfone, e.g., bis(p,p-diphenylene) sulfone.

Polyetherimides are a class of polyimides that comprise more than 1, for example 10 to 1000, or 10 to 500, structural units of formula (3)

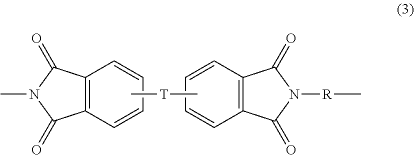

wherein each R is the same or different, and is as described in formula (1).

Further in formula (3), T is —O— or a group of the formula —O—Z—O— wherein the divalent bonds of the —O— or the —O—Z—O— group are in the 3,3′, 3,4′, 4,3′, or the 4,4′ positions. The group Z in —O—Z—O— of formula (3) is also a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (4)

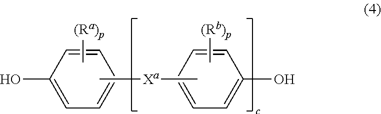

wherein R^{a} and R^{b} can be the same or different and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (4a)

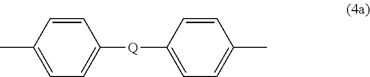

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is a derived from bisphenol A, such that Q in formula (4a) is 2,2-isopropylidene.

In an embodiment in formula (3), p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O wherein Z is a divalent group of formula (3a) and Q is 2,2-isopropylidene. Alternatively, the polyetherimide can be a copolymer comprising additional structural polyetherimide units of formula (1) wherein at least 50 mole percent (mol %) of the R groups are bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety

The polyetherimide copolymer optionally comprises additional structural imide units, for example imide units of formula (1) wherein R is as described in formula (1) and V is a linker of the formulas

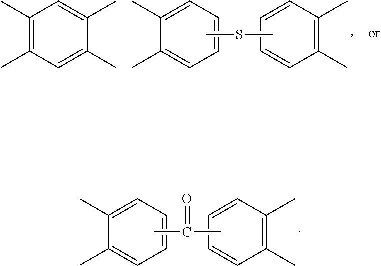

These additional structural imide units can be present in amounts from 0 to 10 mole % of the total number of units, specifically 0 to 5 mole %, more specifically 0 to 2 mole %. In an embodiment no additional imide units are present in the polyetherimide.

The polyimide and polyetherimide can be prepared by any of the methods is well known to those skilled in the art, including the reaction of an aromatic bis(ether anhydride) of formula (5a) or formula (5b)

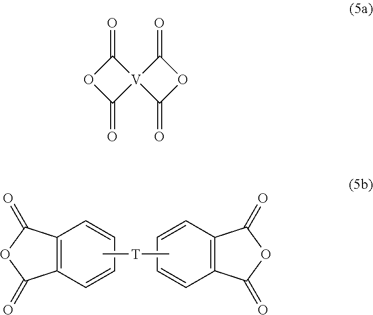

or a chemical equivalent thereof, with an organic diamine of formula (6)

H₂N—R—NH₂ (6)

wherein V, T, and R are defined as described above. Copolymers of the polyetherimides can be manufactured using a combination of an aromatic bis(ether anhydride) of formula (5) and a different bis(anhydride), for example a bis(anhydride) wherein T does not contain an ether functionality, for example T is a sulfone.

Illustrative examples of bis(anhydride)s include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations thereof.

Examples of organic diamines include ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone, and bis(4-aminophenyl) ether. Combinations of these compounds can also be used. In some embodiments the organic diamine is m-phenylenediamine, p-phenylenediamine, sulfonyl dianiline, or a combination including at least one of the foregoing.

Other methods for the manufacture of polyimides and polyetherimides are known, and can include residues derived from chemical equivalents of the foregoing anhydrides and diamines, e.g., residues of bisphenol A, p-phenylenediamine, m-phenylene diamine, bis(p-phenyleneamino) sulfone, or a combination comprising at least one of the foregoing.

The thermoplastic composition can also comprise a poly(etherimide-siloxane) copolymer comprising polyetherimide units of formula (1) and siloxane blocks of formula (7)

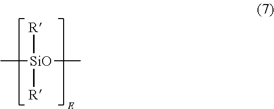

wherein E has an average value of 2 to 100, 2 to 31, 5 to 75, 5 to 60, 5 to 15, or 15 to 40, and each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination comprising at least one of the foregoing. In an embodiment no bromine or chlorine is present, and in another embodiment no halogens are present. Combinations of the foregoing R groups can be used in the same copolymer. In an embodiment, the polysiloxane blocks comprises R′ groups that have minimal hydrocarbon content. In a specific embodiment, an R′ group with a minimal hydrocarbon content is a methyl group.

The poly(etherimide-siloxane)s can be formed by polymerization of an aromatic bisanhydride (5) and a diamine component comprising an organic diamine (6) as described above or mixture of diamines, and a polysiloxane diamine of formula (8)

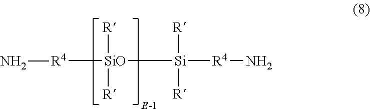

wherein R′ and E are as described in formula (7), and R⁴ is each independently a C₂-C₂₀ hydrocarbon, in particular a C₂-C₂₀ arylene, alkylene, or arylenealkylene group. In an embodiment R⁴ is a C₂-C₂ alkylene group, specifically a C₂-C₁₀ alkylene group such as propylene, and E has an average value of 5 to 100, 5 to 75, 5 to 60, 5 to 15, or 15 to 40. Procedures for making the polysiloxane diamines of formula (8) are well known in the art.

In some poly(etherimide-siloxane)s the diamine component can contain 10 to 90 mole percent (mol %), or 20 to 50 mol %, or 25 to 40 mol % of polysiloxane diamine (8) and 10 to 90 mol %, or 50 to 80 mol %, or 60 to 75 mol % of diamine (6), for example as described in U.S. Pat. No. 4,404,350. The diamine components can be physically mixed prior to reaction with the bisanhydride(s), thus forming a substantially random copolymer. Alternatively, block or alternating copolymers can be formed by selective reaction of (6) and (8) with aromatic bis(ether anhydrides) (5), to make polyimide blocks that are subsequently reacted together. Thus, the poly(siloxane-imide) copolymer can be a block, random, or graft copolymer. In an embodiment the copolymer is a block copolymer.

Examples of specific poly(etherimide-siloxane)s are described in U.S. Pat. Nos. 4,404,350, 4,808,686, and 4,690,997. In an embodiment, the poly(etherimide-siloxane) has units of formula (9)

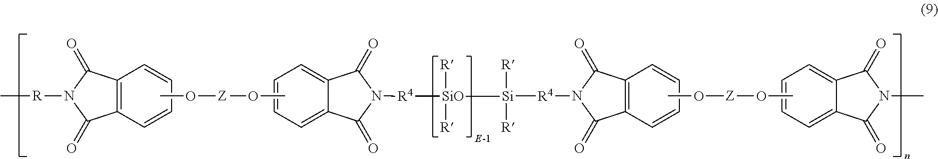

wherein R′ and E of the siloxane are as in formula (7), the R and Z of hie imide are as in formula (1), R⁴ is the same as R⁴ as in formula (8), and n is an integer from 5 to 100. In a specific embodiment, the R of the etherimide is a phenylene, Z is a residue of bisphenol A, R⁴ is n-propylene, E is 2 to 50, 5, to 30, or 10 to 40, n is 5 to 100, and each R′ of the siloxane is methyl.

The relative amount of polysiloxane units and etherimide units in the poly(etherimide-siloxane) depends on the desired properties, and are selected using the guidelines provided herein. In particular, as mentioned above, the block or graft poly(etherimide-siloxane) copolymer is selected to have a certain average value of E, and is selected and used in amount effective to provide the desired wt % of polysiloxane units in the composition. In an embodiment the poly(etherimide-siloxane) comprises 10 to 50 wt %, 10 to 40 wt %, or 20 to 35 wt % polysiloxane units, based on the total weight of the poly(etherimide-siloxane).

In some embodiments the polyimide can be a polyetherimide, preferably a polyetherimide comprising units derived from the reaction of bisphenol A dianhydride and m-phenylene diamine. The polyimide can be a polyetherimide homopolymer, a polyetherimide co-polymer such as a poly(etherimide-siloxane), a poly(etherimide sulfone), or a combination comprising at least one of the foregoing.

The polyimides, specifically the polyetherimides, can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide polymer has a weight average molecular weight (Mw) of 1.000 to 150,000 grams/mole (Dalton), as measured by gel permeation chromatography, using polystyrene standards. In some embodiments the polyetherimide has an Mw of 10,000 to 80,000 Daltons. Such polyetherimide polymers typically have an intrinsic viscosity greater than 0.2 deciliters per gram (dl/g), or, more specifically, 0.35 to 0.7 dl/g as measured in m-cresol at 25° C.

The prepreg can be prepared in any form, where the form is generally dictated by the shape of the substrate. For example, a fabric or a continuous fiber tow, or tows, can provide a layer of substrate. Where a fiber tow comprising continuous, unidirectional fibers is pre-impregnated, the prepreg is generally referred as a unidirectional tape. The thickness of such layers or tapes can vary widely, for example from 5 micrometers to 1 millimeters (mm), and even higher, for example, up to 2 mm.

Composites can be prepared by consolidation of the polyimide prepregs by methods known in art. For example, laminates can be prepared by contacting at least two layers of a prepreg under conditions of heat and pressure sufficient to consolidate the prepreg. Effective temperatures can include 225 to 550° C., at pressures from 20 to 2000 PSI, for example. A laminate can include at least two, preferably from two to one hundred layers of the polyimide prepreg, particularly the polyetherimide prepreg. In some embodiments, all of the layers of the laminate are formed from the polyimide prepreg, in particular the polyetherimide prepreg, or a low density core material. In other embodiments, the laminate can comprise other layers, for example a different prepreg. In some embodiments, all of the prepreg layers used to form the laminate are the polyimide or polyetherimide prepregs produced as described herein.

In some embodiments, a non-prepreg layer can be present such as a release layer, a copper foil, or an adhesive to enhance bonding between two layers. The adhesive can be applied using any suitable method, for example, spreading, spraying, and dipping. The adhesive can be any adhesive that provides the desired adhesion between layer(s) of the prepregs or tapes. An adhesive can be polyvinylbutyral (PVB), ethylene-vinyl acetate copolymer (EVA), an epoxy, an ultraviolet (UV) or water-curable adhesive such as a cyanoacrylate or other acrylic, or a combination comprising at least one or the foregoing.

In some embodiments the prepreg is a tape that includes a plurality of unidirectional fibers, preferably continuous unidirectional fibers. In forming laminates from the tapes, the continuous unidirectional fiber-reinforced polyimide or polyetherimide tapes can be oriented with substantially parallel fibers, where the fibers of one layer are parallel, or more parallel than perpendicular with the fibers of another layer. Alternatively, the continuous unidirectional fiber-reinforced polyimide or polyetherimide tapes can be oriented with substantially non-parallel fibers, where the fibers of one layer are less parallel than perpendicular with the fibers of another layer. In still other embodiments, the continuous unidirectional fiber-reinforced polyimide or polyetherimide tapes are oriented with substantially non-parallel fibers, substantially parallel fibers, or a combination including at least one of the foregoing.

In some embodiments the composite, in particular the laminate, can be thermoformed, for example, vacuum thermoformed, to form a shape.

A polyimide composite, in particular a unidirectional fiber reinforced polyimide laminate formed by a method described herein can have one or more of a density from 1.35 grams/cubic centimeters (g/cc³) to 1.7 g/cm³, preferably from 1.4 g/cm³ to 1.6 g/cm³ as measured by ASTM D792; an average transverse tensile strength from 1,600 to 6,000 pounds per square inch (PSI), as measured by ASTM D3039; a fiber volume fraction from 15 to 82 percent, preferably from 25 to 64 percent; or a fiber weight fraction from 20% to 87%, preferably from 32% to 72%. In some embodiments the polyimide composite has all of the foregoing properties.

An article includes the polyimide composite or polyetherimide composite as described above, including those formed by the methods described herein.

The following examples are provided by way of further illustration, and should not be construed as limiting.

### EXAMPLES

The materials that were used in the examples are provided in Table 1.

TABLE 1

| Component | Description (trade name) | Supplier |
|---|---|---|
| Polyetherimide | Polyetherimide derived | SABIC |
| (PEI) | from bisphenol A dianhydride | |
| | and m-phenylene diamine, | |
| | using either aniline or | |
| | phthalic anhydride as end | |
| | cap (ULTEM 1000) | |
| Methylene chloride | Solvent | Fisher Scientific |
| Sodium dodecyl | Surfactant | Pilot |
| benzene sulfonate | | |
| Surfactant | Nonionic, branched secondary | Sigma Aldrich |
| | alcohol ethoxylate surfactant | |
| | (TERGITOL TMN-10) | |
| Carbon fibers | (HEXTOW AS4 12K) | Hexcel |

### A. Making Polyetherimide Spherical Particles Using Emulsion Process

675 kilograms of polyetherimide (ULTEM 1000) was dissolved in 2697 kilograms of methylene chloride to form a solution with 20% solids. To this, 2739 kilograms of deionized water and 5.82 kilograms of sodium dodecyl benzene sulfonate was added. The resulting solution was emulsified using a high shear homogenizer at 3600 revolutions per minute (rpm). Methylene chloride was removed from the emulsion by spray drying the emulsion into hot water at 80° C., resulting in polymer particle precipitation. The resulting polymer particles were isolated via centrifuge and dried in an oven at 160° C. The polyetherimide particles obtained from the above process (Emulsion I) had spherical morphology (as seen in FIG. 1) and exhibited a volume based particle diameter D100 less than 100 microns and a volume based particle diameter D90 less than 45 microns. The spherical polyetherimide particles prepared via above method was also sieved via 45 micrometer screen to obtain polyetherimide particles with narrower particle size distribution. This sample is labelled as Emulsion II. The characteristics of the polyetherimide particles formed from the above emulsion process is compared with polyetherimide particles formed by a jet milling process in Table 2.

Polyetherimide was made into <45 micron particles using a conventional jet milling process, such as that described in U.S. patent application publication 2003/0181626. This process involves no grinding media. Particles collide with each other under high velocities resulting in size reduction.

TABLE 2
Particle Size Distribution of Polyetherimide Powders
Made by Emulsion and Jet Milled Process.

| | | Particle size, | Particle size, | Particle size, | Particle size, |
|---|---|---|---|---|---|
| | | D100 (volume | D90 (volume | D50 (volume | D10 (volume |
| Process | Morphology | based) | based) | based) | based) |
| Emulsion I | Spherical | 75.8 | 40.2 | 23.2 | 13.4 |
| | | micrometers | micrometers | micrometers | micrometers |
| Emulsion II | Spherical | 58.8 | 25.6 | 9.90 | 3.66 |
| | | micrometers | micrometers | micrometers | micrometers |
| Jet Milled | Non- | 31.0 | 17.7 | 10.4 | 5.93 |
| | spherical | micrometers | micrometers | micrometers | micrometers |

FIG. 1 shows SEM images of polyetherimide particles prepared by a jet milling process (left side) and the emulsion process described above (right side). The spherical nature of particles formed by the emulsion process is clearly seen.

### B. Prepreg Preparation

Polyetherimide particles prepared by the emulsion process (Emulsion I and Emulsion II) described above were made into aqueous dispersion using 3 wt % of polymer particles in water together with the ethoxylate surfactant (TERGITOL TMN-10). The surfactant concentration with respect to polymer concentration in the aqueous dispersion was 2.44%. Similarly, polyetherimide particles made by jet milling process were made into aqueous dispersion using 8.2 wt % of polymer particles in water together with the ethoxylate surfactant (TERGITOL TMN-10). It was observed that with the jet milled polyetherimide particles, it took a higher concentration (8.2 wt %) of these polymer particles in the aqueous dispersion to achieve a fiber volume fraction of about 55%, whereas in the case of emulsion process based polyetherimide spherical particles (Emulsion I and Emulsion II), it took a lower concentration (3 wt %) to achieve a fiber volume fraction of about 55%. It was also observed for the jet milled polyetherimide particles that the amount of particle uptake by the continuous fibers was constant irrespective of their depth of pulling through within the aqueous dispersion batch. In contrast, for the emulsion process based polyetherimide spherical particles (Emulsion I and Emulsion II) that amount of particle uptake by the continuous fibers was observed to be a function of their depth of pulling through within the aqueous dispersion batch. Essentially, for the emulsion process based polyetherimide spherical particles (Emulsion I and Emulsion II) the particle uptake increased with increasing depth of fiber pull through. This provides a method of selecting the particle uptake in the aqueous polymer solution, by changing the depth of pulling the substrate through the aqueous polymer solution. The surfactant concentration with respect to the jet milled polymer concentration in the aqueous dispersion was 2.44%. The percentages are based on a total composition of 100 wt %. The particles were dispersed well using mechanical agitation. Mechanical agitation was continued throughout the preparation of the prepregs.

Prepregs in the form of continuous carbon fiber unidirectional tapes were made using 14 tows of carbon fibers (Hexcel AS4 12K). The final tape dimension was about 3.2 inches (85 mm) in width. Processing conditions and details about the produced UD tapes are provided in Table 3.

TABLE 3
Processing conditions used to produce carbon fiber-polyetherimide unidirectional tapes.

| | | | PEI - Emulsion | |
|---|---|---|---|---|
| | | PEI - Emulsion | process; Sieved | PEI - Jet |
| | | process; Not Sieved | via 45 micron screen | Milling process |
| | | (Tergitol Content: | (Tergitol Content: | (Tergitol Content: |
| | | 0.073%) | 0.073%) | 0.2%) |
| | | Emulsion I | Emulsion II | Jet Milled |
| Spreader station | Comb span (inch) | 4 | 4 | 4 |
| Aqueous Bath | Dipping Depth, | 2 | 2 | 2 |
| | inches | | | |
| Drying Zone | Zone 1 (° F.) | 220 | 220 | 220 |
| | Zone 2 (° F.) | 220 | 220 | 220 |
| | Zone 3 (° F.) | 220 | 220 | 220 |
| | Zone 4 (° F.) | 220 | 220 | 220 |
| | Zone 5 (° F.) | 220 | 220 | 220 |
| Melting Zone | Top Platen (° C.) | 330 | 330 | 330 |
| | Bottom Platen (° C.) | 330 | 330 | 330 |
| | Platens pressure, | 30 | 30 | 30 |
| | pounds per square | | | |
| | inch (PSI) | | | |
| | Nipper pressure, PSI | 40 | 40 | 40 |
| Prepreg pull speed, | inch/min | 8 | 8 | 8 |
| Prepreg dimensions | width, inch | 3.2 | 3.2 | 3.2 |
| | Length, inch | 11.0 | 11.0 | 11.0 |
| | Thickness, inch | 0.006 to 0.012 | 0.006 to 0.012 | 0.006 to 0.012 |
| | weight, grams | 5.31 | 5.16 | 5.07 |
| Prepreg fiber | % | 54.5 | 56.5 | 57.4 |
| volume fraction | | | | |

### Processing Conditions:

Coating section: The spread fibers were pulled under uniform tension through the aqueous polymer dispersion contained in a bath at a speed of 8 inches/minute. This process to make unidirectional fiber reinforced tapes can also be run at slower or faster speeds. The aqueous polymer dispersion was continuously agitated to keep the polymer particles suspended in the slurry. The aqueous polymer dispersion was at room temperature.

Drying section: After the fibers went through the aqueous polymer dispersion bath, they came out as wet polymer particle-coated fibers. These wet polymer particle-coated fibers went through a series of heated zones to remove the water. For the wet polymer particle-coated fibers using particles from both the emulsion and jet milling processes described above, drying was carried out in five heating zones that were set at 220° F. (about 105° C.). The process conditions were chosen to dry the tapes enough to minimize loss of polymer powder in the drying zone.

Melting Zone: Here the dry particles were melted and consolidation of the UD tapes was achieved. The polymer particle coated fibers went through a set of platens (two flat metal plates, one with a tapered depth profile) which were heated and held under pressure of 30 pounds per square inch (PSI) to melt the polymer and fully impregnate the fibers with it. Optionally, the polymer particle coated fibers can also be taken through a shaping/sizing die to form the desired thickness and uniformity of coating for the prepreg, or between heated calendaring rolls. For these experiments, both top and bottom plates were maintained at 330° C. The pre-impregnated plurality of parallel carbon fibers, which were held together by the polymer coming out of the platen (prepreg), had the following dimensions: about 3.2 inches (about 82 mm) width; thickness from about 0.008 inches (about 0.2 mm); weight of about 11 inches (about 280 mm) long prepreg ranging from 5 to 6 grams. Optionally, for polymers sensitive to oxidative degradation, an inert atmosphere such as a nitrogen blanket can be used.

Cooling: In these experiments, the prepreg was cooled in ambient atmosphere, then processed for further conversion into laminates. The prepreg can also be cooled by pulling through chill rolls or in a water bath maintained at an appropriate temperature, such as room temperature. However, and as would be expected, any special cooling means were not necessary for UD tapes described here given the high thermal conductivity of carbon fibers that enabled the tapes to cool quite fast.

### C. Preparation of Composite

Composites in the form of laminates were prepared by stacking twelve pieces of the unidirectional carbon fiber-reinforced polyetherimide tapes measuring about 11 inches (about 280 millimeters) each on top of each other while maintaining the same fiber orientation to produce substantially unidirectional carbon fiber reinforced polyetherimide laminates. All laminates were produced using an autoclave process using a process cycle shown in FIG. 6.

### D. Testing the Composite

The continuous unidirectional fiber reinforced laminate was cut into specimens for transverse (90°) tensile testing as per the ASTM D3039 standard.

The density of the laminate changes as a function of how much volume is occupied by the fiber and the polymer. The polyetherimide polymer used had a density of 1.27 grams/cubic centimeters. The carbon fiber used had a density of 1.79 grams/cubic centimeters.

Laminate Transverse Tensile Strength (TTS): unidirectional carbon fiber reinforced polyetherimide laminates produced using polyetherimide particles formed from the emulsion process described and polyetherimide particles formed from a jet milling process, exhibited statistically in-different average transverse tensile strength, based on 95% confidence interval.

FWF: Fiber weight fraction in percentage. The FWF plus the polymer weight fraction percentage adds up to 100%.

FVF: Fiber Volume Fraction in percentage. The FVF plus the polymer volume fraction percentage adds up to 100%.

Normalized TTS number: The laminate TTS in PSI units divided by FVF divided by 100 to normalize the tensile strength.

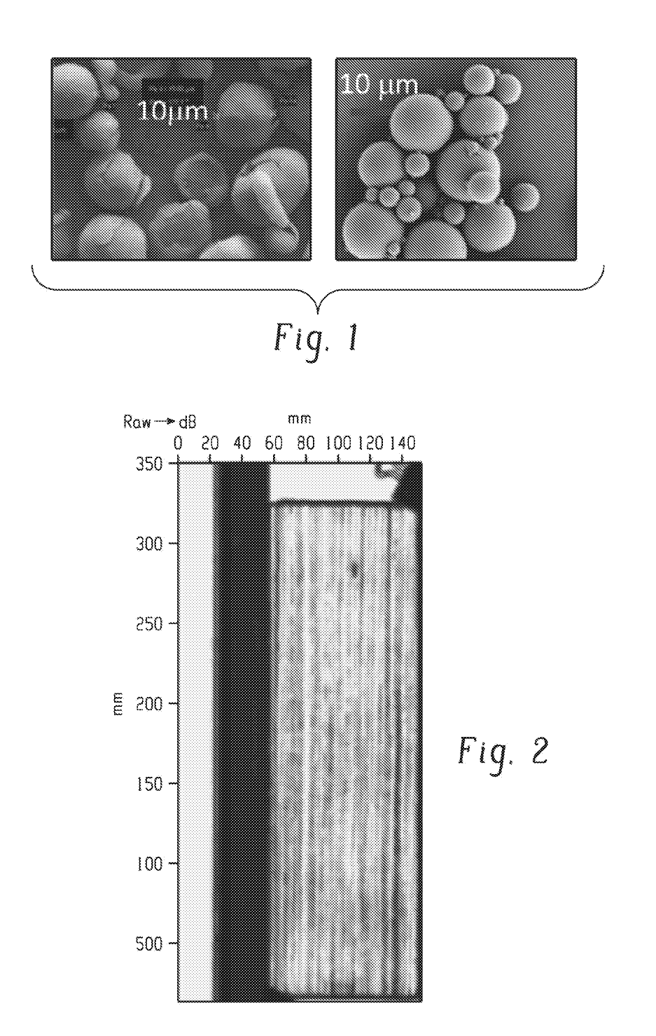

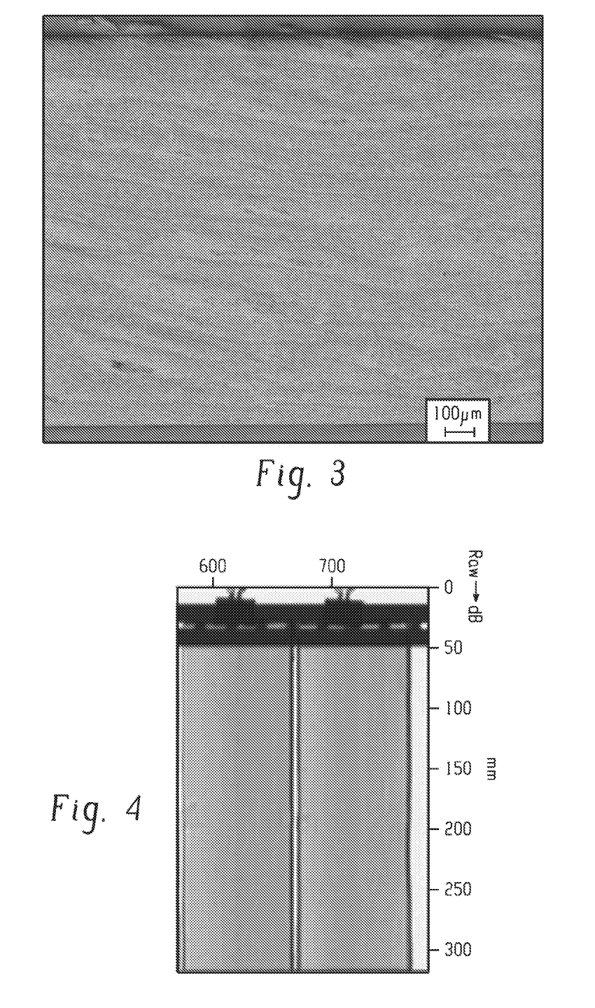

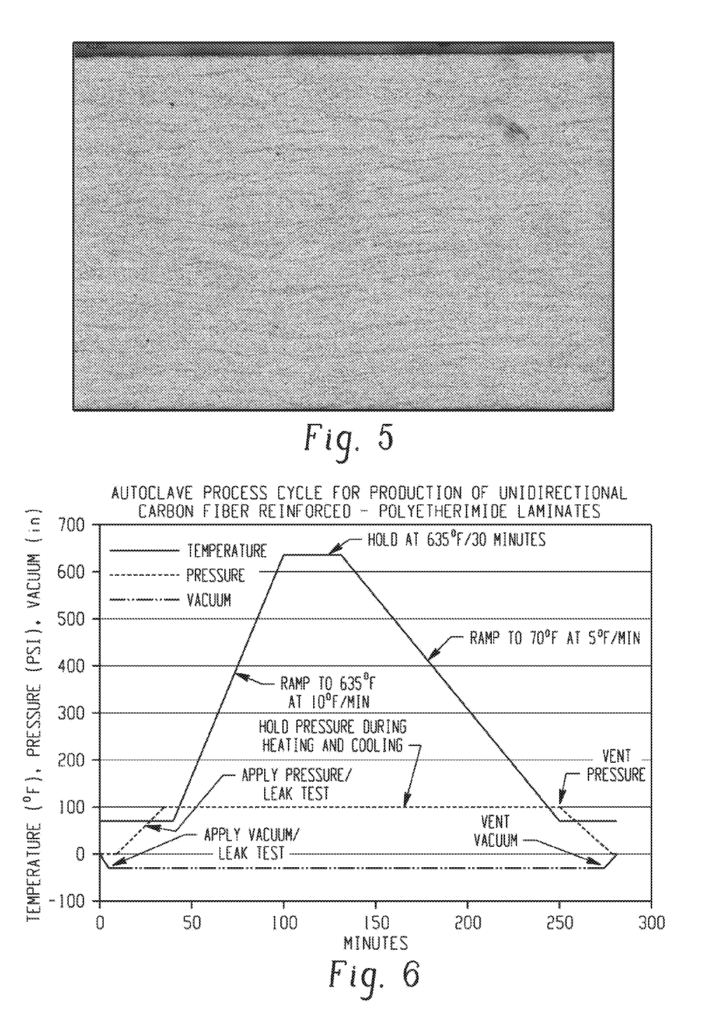

Properties of the laminates prepared using polyetherimide particles prepared from the emulsion process and jet milling process described above are provided in Table 4. FIGS. 2-5 show ultrasonic C-scans using the pulse-echo immersion method and confocal optical microscopy images of laminates formed using either the polyetherimide particles from the emulsion process described above or the jet milling process.

TABLE 4

| | PEI spherical particle, | | | | | |
|---|---|---|---|---|---|---|
| | D100 < 100 micrometers | | | | Jet Milled non- | |
| | TTS, Kilo | | PEI spherical particles, | | spherical PEI particles, | |
| | pounds | | D100 < 60 micrometers | | D100 < 35 micrometers | |
| Test | per square | Normalized | | Normalized | | Normalized |
| specimen | inch (Ksi) | TTS, psi | TTS, Ksi | TTS, psi | TTS, Ksi | TTS, psi |
| 1 | 1.62 | 29.7 | 3.45 | 61.1 | 2.91 | 50.7 |
| 2 | 2.46 | 45.1 | 3.61 | 63.9 | 3.57 | 62.2 |
| 3 | 2.28 | 41.8 | 2.99 | 52.9 | 3.06 | 53.3 |
| 4 | 2.74 | 50.3 | 3.15 | 55.8 | 3.98 | 69.3 |
| 5 | 2.18 | 40.0 | 2.97 | 52.6 | 3.81 | 66.4 |
| 6 | 2.48 | 45.5 | 3.09 | 54.7 | 3.98 | 69.3 |
| Average | 2.29 | 42.1 | 3.2 | 56.8 | 3.6 | 61.9 |
| Standard Deviation | 0.38 | 7.00 | 0.26 | 4.63 | 0.47 | 8.12 |
| Coefficient of | 16.64% | 16.64% | 8.14% | 8.14% | 13.13% | 13.13% |
| variation | | | | | | |
| 95% Confidence | 2.0 to 2.6 | 36.5 to 47.7 | 3.0 to 3.4 | 53.1 to 60.5 | 3.2 to 3.9 | 55.4 to 68.4 |
| Interval on Average | | | | | | |

The concentration of the jet milled polyetherimide particles in the aqueous polymer dispersion was fixed at 8% solids which resulted in a prepreg with a FVF of about 57.4. When the concentration of emulsion based polyetherimide particles in aqueous polymer dispersion (Emulsion I and Emulsion II) was matched with 8% solids, the resulting prepreg showed a FVF of <50.0 indicating that under the same processing conditions to produce the unidirectional tapes or prepregs, the particle uptake by the fibers was higher for the spherical particles formed from the emulsion process. Laminates prepared using polyetherimide particles from the emulsion process and laminates prepared from polyetherimide particles formed from the jet milling process have average transverse tensile strength which are statically not different, within 95% confidence interval.

The compositions, methods, articles and other aspects are further described by the Embodiments below.

### Embodiment 1

A method of manufacturing a polyimide prepreg, including: coating a substrate with an aqueous polymer dispersion to form a coated substrate, wherein the aqueous polymer dispersion comprises polyimide particles having a spherical morphology, and a volume based D100 diameter less than 100 micrometers, and a volume based D90 diameter less than 60 micrometers, and a volume based D50 diameter less than 40 micrometers, or polyimide particles having a volume based D100 diameter from 1 to 100 micrometers, and a volume based D90 diameter from 1 to 60 micrometers, and a volume based D50 diameter from 1 to 40 micrometers, optionally wherein the polyimide particles have a mono-modal, bi-modal, tri-modal or multi-modal volume based size distribution; and heating the coated substrate to form the polyimide prepreg.

### Embodiment 2

The method of Embodiment 1, wherein the polyimide particles have a volume based D100 diameter less than 90 micrometers, preferably less than 80 micrometers, and a volume based D90 diameter less than 55 micrometers, preferably less than 50 micrometers, and a volume based D50 diameter less than 40 micrometers, preferably less than 30 micrometers.

### Embodiment 3

The method of any one or more of Embodiments 1 to 2, wherein the polyimide particles have a volume based D100 diameter less than 70 micrometers, preferably less than 60 micrometers, and a volume based D90 diameter less than 40 micrometers, preferably less than 30 micrometers, and a volume based D50 diameter less than 20 micrometers, preferably less than 10 micrometers.

### Embodiment 4

The method of any one or more of Embodiments 1 to 3, wherein the volume based D100 diameter of the polyimide particles is less than 45 micrometers, preferably less than 40 micrometers, or wherein the volume based D100 diameter of the polyimide particles is from 1 to 45 micrometers, preferably from 5 to 40 micrometers, more preferably from 10 to 30 micrometers.

### Embodiment 5

The method of any one or more of Embodiments 1 to 4, wherein coating comprises immersing the substrate into the aqueous polymer dispersion, preferably for up to 30 minutes; pulling the substrate through the aqueous polymer dispersion; spraying the aqueous polymer dispersion onto the substrate; curtain coating the substrate with the aqueous polymer dispersion, or a combination comprising at least one of the foregoing.

### Embodiment 6

The method of any one or more of Embodiments 1 to 5, wherein heating includes drying at a temperature from 80 to 230° C., preferably 100 to 220° C. and melting at a temperature from 200 to 570° C. preferably 220 to 550° C. for a total heating time of less than 15 minutes.

### Embodiment 7

The method of any one or more of Embodiments 1 to 6, wherein the concentration of the polyimide particles in the aqueous polymer dispersion is between 0.5 and 10 wt %, preferably between 0.5 and 5 wt %, preferably between 1 and 4 wt %.

### Embodiment 8

The method of any one or more of Embodiments 1 to 7, wherein the concentration of the polyimide particles in the aqueous polymer dispersion is between 0.5 and 30 wt %, preferably between 1 and 25 wt %, more preferably between 1 and 10 wt %, more preferably between 1 and 8 wt %.

### Embodiment 9

The method of any one or more of Embodiments 1 to 8, wherein the substrate includes a fibrous material, preferably ceramic fiber, boron fiber, silica fiber, alumina fiber, zirconia fiber, basalt fiber, metal fiber, glass fiber, carbon fiber, polymer fiber or a combination comprising at least one of the foregoing.

### Embodiment 10

The method of any one or more of Embodiments 1 to 9, wherein the substrate includes a woven fabric, non-woven fabric, unidirectional fibers, braid, tow, end, rope, a glass fiber, a carbon fiber, a carbon fiber tow, a carbon fiber tow consisting of plurality of carbon filaments, polyamide fiber, aramid fiber, or a combination comprising at least one of the foregoing.

### Embodiment 11

The method of any one or more of Embodiments 1 to 10, wherein the substrate comprises fibers, and wherein at least a portion of the polyimide particles have D50 diameter that is equal to or is less than the filament diameter.

### Embodiment 12

The method of any one or more of Embodiments 1 to 11, wherein the polyimide is a polyetherimide homopolymer, a polyetherimide copolymer such as a poly(etherimide-siloxane), a poly(etherimide sulfone), or a combination comprising at least one of the foregoing.

### Embodiment 13

The method of any one or more of Embodiments 1 to 12, wherein the polyetherimide homopolymer, polyetherimide copolymer comprises bisphenol A residues and m-phenylene diamine, m-phenylene diamine, bis(p-phenyleneamino) sulfone residues, or a combination comprising at least one of the foregoing diamino residues.

### Embodiment 14

The method of any one or more of Embodiments 1 to 13, wherein the aqueous polymer dispersion further includes a total of 0.1 to 10, or 0.2 to 5 wt %, or 0.2 to 3 wt % of an additive composition including a surfactant, a stabilizer, a colorant, a filler, a polymer latex, a coalescing agent, a co-solvent, or a combination including one or more of the foregoing, wherein the wt % is based on the total weight of the polymer in the aqueous polymer dispersion.

### Embodiment 15

The method of any one or more of Embodiments 1 to 14, wherein the additive is a surfactant or a coalescing agent.

### Embodiment 16

The method of any one or more of Embodiments 1 to 15, wherein the polyimide prepreg has an average density from 1.35 grams/cubic centimeters (g/cm³) to 1.7 g/cc³, preferably from 1.4 g/cm³ to 1.6 g/cm³ as measured by ASTM D792.

### Embodiment 17

The method of any one or more of Embodiments 1 to 16, wherein the polyimide prepreg has a fiber volume fraction from 15% to 82%, preferably from 25% to 64%.

### Embodiment 18

The method of any one or more of Embodiments 1 to 17, wherein the polyimide prepreg has a fiber weight fraction from 20% to 87%, preferably from 32% to 72%.

### Embodiment 19

A method of manufacturing a polyetherimide prepreg, including: pulling a fibrous substrate, preferably carbon fibers, in an aqueous polymer dispersion for less than 30 minutes, the aqueous polymer dispersion comprising 0.5 to 30 wt % of polyetherimide particles having a spherical morphology, and a volume based D100 diameter less than 100 micrometers, and a volume based D90 diameter of less than 60 micrometers, and a volume based D50 diameter of less than 40 micrometers, and from 0.1 to 10 wt %, preferably from 0.2 to 5 wt %, more preferably from 0.2 to 3 wt % of an additive composition comprising a surfactant, a stabilizer, a colorant, a filler, a polymer latex, a coalescing agent, a co-solvent, or a combination comprising at least one of the foregoing, wherein the wt % is based on the total weight of polymer in the aqueous polymer dispersion, to form a coated substrate; and heating the coated substrate to between 200 and 550° C. for less than 15 minutes, to form a fiber reinforced polyetherimide prepreg, preferably in the form of a continuous unidirectional fiber reinforced tape.

### Embodiment 20

A polyimide prepreg or polyetherimide prepreg formed by the method of any one or more of Embodiments 1 to 19.

### Embodiment 21

A polyimide or polyetherimide composite produced by consolidating prepregs formed by the method of any one or more of Embodiments 1 to 20.

### Embodiment 22

The composite of Embodiment 21, in the form of a laminate produced by consolidating at least two, preferably from two to one hundred layers of the prepreg under heat and pressure.

### Embodiment 23

The composite of Embodiment 21, wherein the prepreg layers of are continuous unidirectional fiber-reinforced polyimide or polyetherimide tapes.

### Embodiment 24

The composite of any one or more of Embodiments 21 to 23, further including an adhesive between the layers.

### Embodiment 25

The composite of any one or more of Embodiments 21 to 24, wherein the continuous unidirectional fiber reinforced polyimide or polyetherimide tapes are oriented with substantially parallel fibers.

### Embodiment 26

The composite of any one or more of Embodiments 21 to 25, wherein the continuous unidirectional fiber reinforced polyimide or polyetherimide tapes are oriented with substantially non-parallel fibers.

### Embodiment 27

The composite of any one or more of Embodiments 21 to 26, wherein the continuous unidirectional fiber reinforced polyimide or polyetherimide tapes are oriented with substantially non-parallel fibers, substantially parallel fibers, or a combination comprising at least one of the foregoing.

### Embodiment 28

The composite of any one or more of Embodiments 21 to 27, wherein the laminate is thermoformed to form a shape.

### Embodiment 29

The composite of any one or more of Embodiments 21 to 28, wherein the composite has a density from 1.35 grams/cubic centimeters (g/cm³) to 1.7 g/cc³, preferably from 1.4 g/cm³ to 1.6 g/cm³ as measured by ASTM D792.

### Embodiment 30

The composite of any one or more of Embodiments 21 to 29 wherein the composite has a transverse tensile strength from 1,600 to 6,000 PSI, as measured by ASTM D3039.

### Embodiment 31

The composite of any one or more of Embodiments 21 to 30, wherein the composite has a fiber volume fraction from 15% to 82%, preferably from 25% to 64%.

### Embodiment 32

The composite of any one or more of Embodiment 21 to 31, wherein the composite has a fiber weight fraction from 20% to 87%, preferably from 32% to 72%.

### Embodiment 33

An article comprising the polyimide prepreg or polyetherimide prepreg formed by the method of any one or more of Embodiments 1 to 20.

### Embodiment 34

An article comprising the composite of any one or more of Embodiments 21 to 32.

In general, the compositions, methods, or articles can alternatively comprise, consist of, or consist essentially of, any appropriate components or steps herein disclosed. The invention can additionally, or alternatively, be formulated so as to be devoid, or substantially free, of any components, materials, ingredients, adjuvants, or species, or steps used in the prior art compositions or that are otherwise not necessary to the achievement of the function and/or objectives of the present claims.

The terms “a” and “an” do not denote a limitation of quantity, but rather denote the presence of at least one of the referenced item. The term “or” means “and/or” unless clearly indicated otherwise by context. Reference throughout the specification to “one embodiment.” “another embodiment”, “an embodiment,” and so forth, means that a particular element (e.g., feature, structure, and/or characteristic) described in connection with the embodiment is included in at least one embodiment described herein, and may or may not be present in other embodiments. In addition, it is to be understood that the described elements can be combined in any suitable manner in the various embodiments. “Optional” or “optionally” means that the subsequently described event or circumstance may or may not occur, and that the description includes instances where the event occurs and instances where it does not. The endpoints of all ranges directed to the same component or property are inclusive of the endpoints, are independently combinable, and include all intermediate points and ranges (e.g., ranges of “up to 25 wt %, or, more specifically, 5 wt % to about 20 wt %,” is inclusive of the endpoints and all intermediate values of the ranges of “5 wt % to 25 wt %,” such as 10 wt % to 23 wt %, etc.).

The suffix “(s)” as used herein is intended to include both the singular and the plural of the term that it modifies, thereby including one or more of that term (e.g., the additive(s) includes one or more additives). The terms “first,” “second,” and the like, “primary,” “secondary,” and the like, as used herein do not denote any order, quantity, or importance, but rather are used to distinguish one element from another. The term “combination” is inclusive of blends, mixtures, alloys, reaction products, and the like. Unless defined otherwise, technical and scientific terms used herein have the same meaning as is commonly understood by one of skill in the art to which this invention belongs.

Unless specified to the contrary herein, all test standards are the most recent standard in effect at the time of filing this application. Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. As used herein, the term “hydrocarbyl” includes groups containing carbon, hydrogen, and optionally one or more heteroatoms (e.g., 1, 2, 3, or 4 atoms such as halogen. O, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) or propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclization(s). “Aryl” means a monovalent, monocyclic, or polycyclic aromatic group (e.g., phenyl or naphthyl). “Arylene” means a divalent, monocyclic, or polycyclic aromatic group (e.g., phenylene or naphthylene). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms, wherein each heteroatom is independently N, O, S, or P.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₄₋₁₂ cycloalkenyl, C₆₋₁₂ aryl, C₇₋₁₃ arylalkylene (e.g., benzyl). C₇₋₁₂ alkylarylene (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the group, including those of the substituent(s).

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of manufacturing a polyimide prepreg, comprising:
coating a substrate with an aqueous polymer dispersion to form a coated substrate, wherein the aqueous polymer dispersion comprises
polyimide particles having
a spherical morphology, and
a volume based D100 diameter less than 100 micrometers, and
a volume based D90 diameter less than 45 micrometers, and
a volume based D50 diameter less than 25 micrometers,
or polyimide particles having
a volume based D100 diameter from 1 to 100 micrometers, and
a volume based D90 diameter from 1 to 45 micrometers, and
a volume based D50 diameter from 1 to 25 micrometers,
optionally wherein the polyimide particles have a mono-modal, bi-modal, tri-modal or multi-modal volume based size distribution; and
heating the coated substrate to form the polyimide prepreg.

2. The method of claim 1, wherein coating comprises immersing the substrate into the aqueous polymer dispersion, preferably for up to 30 minutes; spraying the aqueous polymer dispersion onto the substrate; curtain coating the substrate with the aqueous polymer dispersion, or a combination comprising at least one of the foregoing.

3. The method of claim 1, wherein heating comprises drying at a temperature from 300 to 475° C. and melting at a temperature from 300 to 480° C. for a total heating time of less than 15 minutes.

4. The method of claim 1, wherein the concentration of the polyimide particles in the aqueous polymer dispersion is between 0.5 and 30 wt %, preferably between 1 and 25 wt %, more preferably between 2 and 10 wt %.

5. The method of claim 1, wherein the substrate comprises a fibrous substrate, preferably comprising ceramic fiber, boron fiber, silica fiber, alumina fiber, zirconia fiber, basalt fiber, metal fiber, glass fiber, carbon fiber, polymer fiber or a combination comprising at least one of the foregoing.

6. The method of claim 1, wherein the substrate comprises a woven fabric, non-woven fabric, unidirectional fibers, braid, tow, end, rope, or a combination comprising at least one of the foregoing.

7. The method of claim 1, wherein the substrate comprises a glass fiber, a carbon fiber, a carbon fiber tow, or a combination comprising at least one of the foregoing.

8. The method of claim 1, wherein the substrate comprises fibers, and wherein at least a portion of the volume based D90 diameter of the polyimide particles overlaps with the fiber diameter or wherein at least a portion of the volume based D50 diameter of the polyimide particles overlaps with the fiber diameter.

9. The method of claim 1, wherein the substrate comprises fibers and wherein the volume based D90 diameter of the polyimide particles is less than the diameter of a fiber.

10. The method of claim 1, wherein the volume based D90 diameter of the polyimide particles is less than 45 micrometers, preferably less than 40 micrometers, or wherein the volume based D90 diameter of the polyimide particles is from 1 to 45 micrometers, preferably from 5 to 40 micrometers, more preferably from 10 to 40 micrometers.

11. The method of claim 1, wherein the polyimide is a polyetherimide homopolymer, a polyetherimide co-polymer such as a poly(etherimide-siloxane), a poly(etherimide sulfone), or a combination comprising at least one of the foregoing.

12. The method of claim 1, wherein the aqueous polymer dispersion further comprises a total of 0.1 to 5 wt % of an additive composition comprising a surfactant, a stabilizer, a colorant, a filler, a polymer latex, a coalescing agent, a co-solvent, or a combination comprising at least one of the foregoing, wherein the wt % is based on the total weight of the aqueous polymer dispersion.

13. A method of manufacturing a polyetherimide prepreg, comprising:
immersing a substrate, preferably carbon fibers, in an aqueous polymer dispersion for less than 30 minutes, the aqueous polymer dispersion comprising
0.5 to 30 wt % of polyetherimide particles having a spherical morphology, and a volume based D100 diameter less than 100 micrometers, and a volume based D90 diameter of less than 45 micrometers, and a volume based D50 diameter of less than 25 micrometers, and
from 0.1 to 5 wt %, preferably from 0.2 to 3 wt %, more preferably from 0.2 to 1.5 wt % of an additive composition comprising a surfactant, a stabilizer, a colorant, a filler, a polymer latex, a coalescing agent, a co-solvent, or a combination comprising at least one of the foregoing,
to form a coated substrate; and
heating the coated substrate to between 300 and 480° C. for less than 15 minutes, to form a fiber reinforced polyetherimide prepreg, preferably in the form of a continuous unidirectional fiber reinforced tape.

14. A polyimide prepreg or polyetherimide prepreg formed by the method of claim 13.

15. A polyimide or polyetherimide composite produced by consolidating a prepreg formed by the method of claim 13.

16. The composite of claim 15, in the form of a laminate produced by consolidating at least two, preferably from two to one hundred layers of the prepreg under heat and pressure.

17. The composite of claim 16, wherein the prepreg layers are in the form of continuous unidirectional fiber-reinforced tapes.

18. The composite of claim 15, wherein the composite is thermoformed to form a shape.

19. The composite of claim 15, wherein the composite has one or more of
a transverse tensile strength from 2,800 to 6,000 PSI, as measured by ASTM D3039,
a normalized transverse tensile strength number (transverse tensile strength/percent fiber volume fraction) from 80 to 120,
a fiber volume fraction from 15% to 82%, preferably from 26% to 64%,
a fiber weight fraction from 20% to 87%, preferably from 33% to 72%, or
an average density from 1.35 grams/cubic centimeters (g/cm³) to 1.7 g/cm³, preferably from 1.4 g/cm³ to 1.6 g/cm³ as measured by as measured by ASTM D792.

20. An article comprising the composite of claim 15.
